(19) United States
(12) Patent Application Publication
(10) Pub. No.: US 2007/0055996 A1
(43) Pub. Date: Mar. 8, 2007

(54) Full digital home cinema

(75) Inventor: Fabien M.J. Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,848

(22) PCT Filed: Sep. 1, 2004
(86) PCT No.: PCT/IB04/51664

§ 371 Date: Mar. 6, 2006

(30) Foreign Application Priority Data
Sep. 4, 2003 (US) 60/500,075

(51) Int. Cl. H04N 7/18; H04N 7/16

(52) U.S. Cl. 725/80; 725/82; 725/74; 725/6

(57) ABSTRACT

A home entertainment system (100) includes modules (120, 135, 140), connected by digital links (115, 125, 130), which do not have redundant capabilities. A gateway (110) receives external signals from the Internet, digital cable or satellite network, or digital terrestrial network. The gateway is connected to a storage/playback module (135), including a DVD/CD-RW (520) and/or hard drive (HD) (530), a digital audio amplifier module (140), and a video display module (120). The storage/playback module (135) plays back and record content. Copyright protection allows a user to store programs on the HD, to back them up on a DVD, or to record directly on DVD. The audio amplifier includes an audio decoder (420) to provide audio outputs, and has a control panel to play back music from the HD or DVD player. The video display module supports only video capabilities and includes a video decoder (320). The modules share a conditional access component (220) at the gateway.

The invention relates generally to a home entertainment system.

Many different types of home entertainment products are available today. These products generally are centered around the television, and have numerous connectors for audio, video and possibly digital and analog links. The connectors may include audio connectors, such as Dolby AC3, 5.1 (Dolby digital surround sound with five speakers and one sub-woofer) and the like, and video connectors such as for SCART cables. Moreover, there is a large amount of redundant capability among the different products. For example, there is no need for AC3 decoding capability on gateways such as a set-top box (STB) or free to view terrestrial (FTV) box, or on a re-writable DVD (DVD-RW) and an audio amplifier. Likewise, a storage/playback product such as DVD player has various specialized integrated circuits and software to perform audio and video decoding. However, the television, amplifier and set-top box also have audio decoders. In another example, consider the combination of a set-top box and television. Each device has a tuner and a perhaps a number of audio outputs, e.g., jacks, that are not used. These redundancies translate into extra manufacturing costs and increased complexity for the user in setting up and using the products.

The present invention addresses the above and other issues.

In a particular aspect of the invention, a home entertainment system is provided that includes a gateway for receiving an external digital audio/video signal having audio and video data components, and a video display module, an audio amplifier module, and a storage/playback module connected to the gateway via respective digital links. The video display module is dedicated to displaying the video data components, the audio amplifier module is dedicated to reproducing the audio data components, and the storage/playback module is dedicated to storage/playback functions for storing and playing back at least one of the audio and video data components. In this manner, redundant components are avoided and costs are reduced. Moreover, resources at the gateway such as a conditional access component can be shared by the modules.

A corresponding module in a home entertainment system, and a method for providing a home entertainment system, are also provided.

In the drawings:

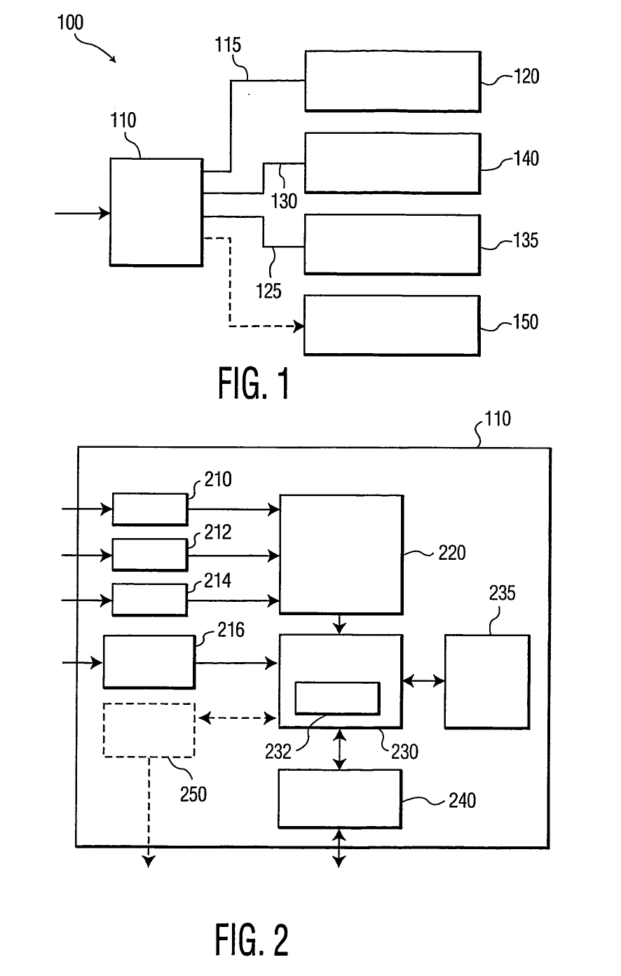

FIG. 1 illustrates a block diagram of a home entertainment system according to the invention;

FIG. 2 illustrates a gateway according to the invention;

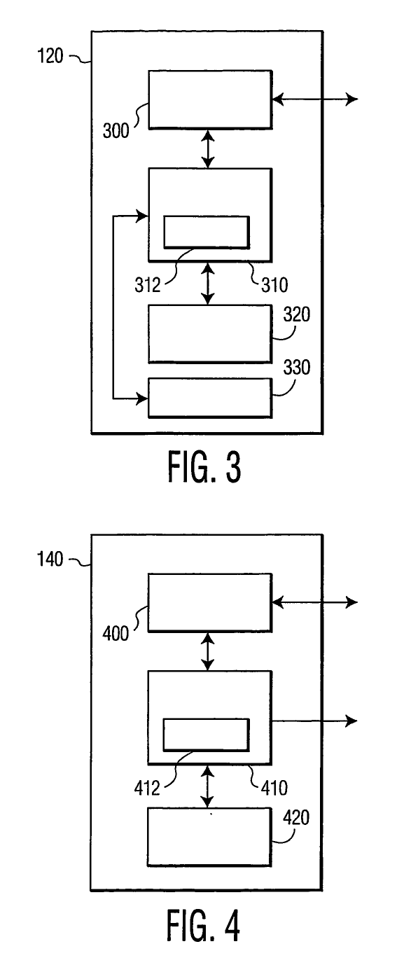

FIG. 3 illustrates a video display module according to the invention;

FIG. 4 illustrates an audio amplifier module according to the invention; and

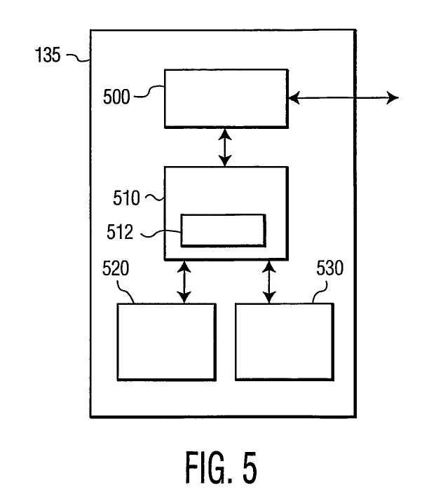

FIG. 5 illustrates a storage/playback module according to the invention.

In the drawings, like-numbered elements correspond to one another.

FIG. 1 illustrates a block diagram of a home entertainment system according to the invention. The home entertainment system 100 includes a number of modules or standalone components that are dedicated to performing a specific function. A gateway 110 is connected to receive an external signal such as from the Internet, or other broadcast signals from an antenna, cable or satellite dish. For example, the gateway 110 may include a set-top box for receiving external audio/video signals from a digital cable network, satellite network, digital terrestrial network, and/or the Internet. The audio/video signals include audio and video data portions or components, such as data packets. The gateway 110 is connected via a respective digital link 115 to a video display module 120, via a respective digital link 130 to a digital audio amplifier module 140, and via a respective digital link 125 to a storage/playback module 135 that includes, e.g., at least a DVD/CD-RW or hard drive (HD), and, which may provide multi-channel surround sound capabilities such as for Dolby 5.1. The storage/playback module 135 may also be connected directly to the audio amplifier module 140 via a digital link. The gateway 110 may be coupled to speakers 150 if the gateway 110 includes an optional audio decoder.

FIG. 2 illustrates a gateway according to the invention. The gateway 110 includes different tuners 210, 212 and 214 for receiving different audio/video streams, such as from satellite, cable and terrestrial networks, respectively. The gateway 110 may also have a network interface 216 such as a telephone link for receiving Internet data, e.g., via the TCP/IP protocol. Internet data may also be embedded in any of the satellite, cable and terrestrial signals. One or more conditional access (CA) components 220 are used to descramble the received audio/video data when it is scrambled. A control 230 with memory 232 controls the processing and flow of the scrambled or descrambled audio/video data or Internet data. The gateway 110 communicates with the other modules via digital interfaces 240, such as one provided according to the IEEE 1394 standard. An optional audio decoder 250 provides an audio signal to speakers. Generally, the gateway 110 may provide various applications. The tuners 210, 212 and 214 may handle signals that are provided in various formats, e.g., DVB—Digital Video Broadcasting, ATSC—Advanced Television Systems Committee, or OpenCable formats. The tuners 210, 212 and 214 and the conditional access (CA) component 220 allow the gateway 110 to provide system control and capture of audio/video (A/V) input signals, as well as transport of A/V streams to the other modules over the digital links without A/V decoding.

In particular, as mentioned, the external audio/video signals received by the gateway 110 may include scrambled and encoded audio/video data. For example, the audio/video data may be encoded according to a scheme such as MPEG-2 to provide a reliable, bandwidth efficient communication. Various encoding techniques such as motion compensation and estimation are used to reduce the amount of video data that is needed to represent a picture. Similarly, audio encoding techniques such as Dolby AC3 use perceptual coding to allow the use of lower data rates while optimising the perceived sound quality. However, such techniques are processor-intensive and therefore require a decoder with a substantial amount of decoding power. The encoded audio/video signal is scrambled using conditional access techniques such as encryption to ensure that only authorized subscribers can access the data. The conditional access component 220 may be provided with the appropriate information for accessing the data in various ways, such as via a smart card reader 235 that reads a smart card that the user provides.

The gateway 110 may pass the audio/video data to the other modules 120, 135 and 140 in either the scrambled or descrambled format. For example, the descrambled video and audio data may be passed to the video display module 120 and audio amplifier module 140, respectively, if the user has requested to play a television program directly from the received audio/video stream. Or, the gateway 110 may pass the scrambled audio/video data to the storage/playback module 135 for storage thereat. The stored data can then be accessed later by the video display module 120 and/or audio amplifier module 140 by sending a request to the storage/playback module 135, via the gateway 110, to obtain the scrambled audio/video data. The gateway 110 then descrambles the data using the conditional access component 220, and provides the descrambled data to the video display module 120 and/or audio amplifier module 140. In any case, the descrambled and encoded video data is decoded at the video display module 120 for display thereat, and the descrambled and encoded audio data is decoded at the audio amplifier module 140 for reproduction thereat. The gateway 110, as well as the modules 120, 135 and 140 may be provided with the appropriate components for achieving the functionality discussed herein. In the gateway 110, the components may include a control 230, memory 232 and software that is stored in the memory 232 and executed by the control 230 to achieve the desired functionality.

FIG. 3 illustrates a video display module according to the invention. The video display module 120 supports only video capabilities and thus includes a video decoder 320 for decoding the descrambled, encoded video signal provided to it by the gateway 110 via the respective digital link 115. The video display module 120 communicates with the gateway via a digital interface 300, and includes a control 310 with memory 312 for executing software to achieve the desired functionality. The video decoder 320 may have the capability to decode video data in different formats. The display 330, such as a flat panel display, provides the video output to the user.

FIG. 4 illustrates an audio amplifier module according to the invention. The digital audio amplifier 140 provides all necessary types of audio outputs, such as for connecting to the speakers 150, and may have a control panel to allow the user to playback music from the storage/playback module 135. An audio decoder 420, such as an AC3/stereo decoder, may be included for decoding the descrambled, encoded audio signal provided to it by the gateway 110 via the respective digital link 130. The audio decoder 420 may have the capability to decode audio data in different formats. Optionally, an audio decoder 250 is provided in the gateway 110 so that a decoded audio signal is provided directly from the gateway 110 to the speakers 150. This approach may be used if the digital audio amplifier 140 is not used. The speakers 150 (FIG. 1) are also connected to the digital audio amplifier 140 for reproducing sound. The audio amplifier module 120 communicates with the gateway 110 via a digital interface 400, and includes a control 410 with memory 412 for executing software to achieve the desired functionality, including audio amplification.

FIG. 5 illustrates a storage/playback module according to the invention. The storage/playback module 135 communicates with the gateway 110 via a digital interface 500, and includes a control 510 with memory 512 for executing software to achieve the desired functionality, including data storage and playback. The storage/playback module 135 only plays back and records content, and may have the capability to store and playback audio and video data in different formats, and may include a DVD-RW storage/player 520 and an HD storage/player 530, including the appropriate optical or magnetic heads for reading and writing data from/to an optical or magnetic storage medium. The storage/playback module 135 may also provide copyright protection features to allow the user to store programs on the hard disk (HD), to back them up on a DVD or to record directly on DVD.

The storage/playback module 135 and the video display 120 have no audio capabilities such as audio decoding. Similarly, the audio amplifier module 140 has no video decoding capability, and the video display module 120 generally need not have audio capabilities, such as audio decoding. However, the storage/playback module 135 can record/playback content from and to the digital link 125 to allow the video display module 120 to access stored video data, and to allow the audio amplifier module 140 to access stored audio data. For example, the video display module 120 and/or audio amplifier module 140 can send a request to access the stored video and audio data, respectively, via the gateway 110. The gateway 110 retrieves the stored video and audio data and provides it to the video display module 120 and/or audio amplifier module 140, respectively. Descrambling is performed by the conditional access component 220 if needed.

Advantageously, the home entertainment network 100 with dedicated modules 120, 135 and 140, which do not have redundant capabilities, reduces the cost per product by removing decoders where they are not necessary. Additionally, the use of digital links to connect the modules 120, 135 and 140 with the gateway 110 limits the number of cables at the back of the devices, thereby easing the installation process and providing a neater installation. For example, the digital links may be provided based on the IEEE 1394 standard. This allow the modules 120, 135 and 140 to share A/V streams, which for example, can be taped in by the gateway 110 and used by the video display module 120, audio amplifier module 140 and the storage/playback module 135. In another case, the storage/playback module 135 can record a TV program from the gateway 110 while the display 120 is showing another TV program. The flexibility offered by the use of the digital links allow us to easily extend the home cinema system 100 by providing new modules and sharing the capabilities among the modules. Moreover, the different digital links may be provided using different standards, if desired.

Instead of adding hardware and software to each component in a home entertainment system, which increases expenses unnecessarily, the modules of the present invention can be thought of as bricks that are cemented by digital links. Each brick or module is dedicated to one type of functionality/service and embeds only the required hardware and software. The home entertainment system architecture is more like a PC motherboard, where all the resources are connected around a digital link (the PC bus) and they are dedicated. Thus, the television is replaced by a display with video only capabilities, and maybe limited audio. A set-top box or gateway contains only tuners, while a DVD player only includes a player, and so forth. With such a system, we can have more resources per box that are shared while still providing an advanced, high-performance system.

Another advantage involves copyright protection since the data may be provided on the digital links in a format that cannot be recorded and reproduced without decoding, e.g., such as for burning (writing to) a DVD. For example the DVD at the storage/playback module 135 can record a scrambled MPEG-2 transport stream, which cannot be played directly by the video display module 120. In order to play the recording, the stream would have to go through the conditional access component 220 at the gateway 110. This is exactly the kind of flexibility offered by the full digital home cinema of the present invention, e.g., where the conditional access component 220 becomes a resource shared by all the modules of the system. The home entertainment system of the present invention may be used with an open specification for networking digital home entertainment products such as the Home Audio Video Interoperability or HAVi standard. Other standards may be used if desired.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A home entertainment system, comprising:
a gateway (110) for receiving an external digital audio/video signal having audio data components and video data components; and
a video display module (120), an audio amplifier module (140), and a storage/playback module (135) connected to the gateway via respective digital links (115, 130, 125); wherein:
the video display module (120) is dedicated to displaying the video data components, the audio amplifier module (140) is dedicated to reproducing the audio data components, and the storage/playback module (135) is dedicated to storage/playback functions for storing and playing back at least one of the audio data components and video data components.

2. The home entertainment system of claim 1, wherein:
the storage/playback module (135) comprises at least one of a DVD/CD-RW (520) and a hard drive (HD) (530).

3. The home entertainment system of claim 1, wherein:
the video display module (120) comprises a video decoder (320) for decoding encoded video signals provided to it by the gateway (110) via the respective digital link (115).

4. The home entertainment system of claim 1, wherein:
the audio amplifier module (140) comprises an audio decoder (420) for decoding encoded audio signals provided to it by the gateway (110) via the respective digital link (130).

5. The home entertainment system of claim 1, wherein:
the external digital audio/video signal is from the Internet.

6. The home entertainment system of claim 1, wherein:
the external digital audio/video signal is from at least one of a digital cable network, a digital satellite network, and a digital terrestrial network.

7. The home entertainment system of claim 1, wherein:
the audio amplifier module (140) plays audio data retrieved from the storage/playback module (135) by the gateway (110).

8. The home entertainment system of claim 1, wherein:
the video display module (120) plays video data retrieved from the storage/playback module (135) by the gateway (110).

9. The home entertainment system of claim 1, wherein:
the storage/playback module (135) and video display module (120) have no audio decoding capability.

10. The home entertainment system of claim 1, wherein:
the audio amplifier module (!40) has no video decoding capability.

11. The home entertainment system of claim 1, wherein:
the gateway (110) comprises a plurality of digital tuners (210, 212, 214) for receiving digital signals from respective different digital networks.

12. The home entertainment system of claim 1, wherein:
the audio and video data components are scrambled;
the gateway (110) comprises a conditional access (CA) component (220) for descrambling the scrambled audio and video data components to provide descrambled audio and video data components.

13. The home entertainment system of claim 12, wherein:
the conditional access module (220) can be accessed by the video display module (120), audio amplifier module (140), and storage/playback module (135) to receive the descrambled and encoded audio and video data components via their respective digital links (115, 130, 125).

14. The home entertainment system of claim 1, wherein:
the gateway (110) comprises a conditional access (CA) component (220);
the audio and video data components are scrambled;
the gateway (110) provides the scrambled audio and video data components for storage at the storage/playback module (135); and
upon request of the video display module (120), the gateway (110) retrieves the scrambled video data components from the storage/playback module (135) and descrambles the scrambled video data components at the conditional access component (220) to provide descrambled video data components to the video display module (120) for decoding and display thereat.

15. The home entertainment system of claim 1, wherein:
the gateway (110) comprises a conditional access (CA) component (220);
the audio and video data components are scrambled;
the gateway (110) provides the scrambled audio and video data components for storage at the storage/playback module (135); and
upon request of the audio amplifier module (140), the gateway (110) retrieves the scrambled audio data components from the storage/playback module (135) and descrambles the scrambled audio data components at the conditional access component (220) to provide descrambled audio data components to the audio amplifier module (140) for decoding and reproduction thereat.

16. The home entertainment system of claim 1, wherein:
the storage/playback module (135) supports copyright protection features to control data storage thereat.

17. A module in a home entertainment system, the module comprising:
means for receiving (300, 400, 500) at least one of encoded audio data components and encoded video data components of a digital audio/video signal from a gateway (110) in the home entertainment system (100);
wherein the gateway (110) receives the digital audio/video signal from an external source;
at least one digital link (115, 130, 125) for linking the means for receiving (300, 400, 500) to the gateway; and
means (320, 330; 420; 520, 530) dedicated to one of: decoding and displaying the encoded video data components, decoding and reproducing the encoded audio data components, and performing storage/playback functions for storing and playing back at least one of the encoded audio data components and the encoded video data components.

18. A method for providing a home entertainment system, comprising:
receiving an external digital audio/video signal at a gateway (110), the external digital audio/video signal having encoded audio data components and encoded video data components;
communicating at least the encoded video data components to a dedicated video display module (120) via a respective digital link (115) for decoding and displaying;
communicating at least the encoded audio data components to a dedicated audio amplifier module (140) via a respective digital link (130) for decoding and reproducing; and
communicating at least one of the encoded audio data components and encoded video data components to a dedicated storage/playback module (135) via a respective digital link (125) for performing storage/playback functions.
